(19) United States
(12) Patent Application Publication
(10) Pub. No.: US 2026/0270450 A1
(43) Pub. Date: Sep. 10, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Zhaobin ZHANG, Los Angeles, CA (US); Semih Esenlik, Los Angeles, CA (US); Yaojun Wu, Beijing (CN); Meng Wang, Beijing (CN); Kai Zhang, Los Angeles, CA (US); Li Zhang, Los Angeles, CA (US)

(21) Appl. No.: 19/658,304

(22) Filed: Apr. 24, 2026

Related U.S. Application Data
(63) Continuation of application No. PCT/CN2024/126780, filed on Oct. 23, 2024.

(30) Foreign Application Priority Data
Oct. 24, 2023 (WO) PCT/CN2023/126163

(51) Int. Cl. H04N 19/184; H04N 19/13; H04N 19/196; H04N 19/70

(52) U.S. Cl. CPC H04N 19/184; H04N 19/13; H04N 19/196; H04N 19/70

(57) ABSTRACT

A solution for visual data processing is provided. A method for visual data processing is proposed. The method comprises: performing a conversion between visual data and a bitstream of the visual data with a neural network (NN)-based model, the bitstream comprising a first indication indicating a level to which the bitstream conforms.

### CROSS REFERENCE TO RELATED APPLICATIONS

This application is a continuation of International Application No. PCT/CN2024/126780, filed on Oct. 23, 2024, which claims the benefit of International Application No. PCT/CN2023/126163, filed on Oct. 24, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a bitstream of the visual data with a neural network (NN)-based model, the bitstream comprising a first indication indicating a level to which the bitstream conforms.

Based on the method in accordance with the first aspect of the present disclosure, the bitstream comprises an indication indicating a level to which the bitstream conforms. Compared with the conventional solution lacking such an indication, the proposed method can advantageously support different levels of coding configurations. Thereby, the coding flexibility and coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a conversion between the visual data and the bitstream with a neural network (NN)-based model, the bitstream comprising a first indication indicating a level to which the bitstream conforms.

In a fifth aspect, a method for storing a bitstream of visual data is proposed. The method comprises: performing a conversion between the visual data and the bitstream with a neural network (NN)-based model, the bitstream comprising a first indication indicating a level to which the bitstream conforms; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example JPEG AI decoder structure;

FIG. 8 illustrates an example JPEG AI decoder for one component;

FIG. 9 illustrates differences between base OP and high OP of JPEG AI decoder;

FIG. 10 illustrates an example of decoding the same bitstream of luma component with three branches in accordance with embodiments of the present disclosure;

FIG. 11 illustrates another example of decoding the same bitstream of luma component with three branches in accordance with embodiments of the present disclosure;

FIG. 12 illustrates a flowchart of a method for visual data processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

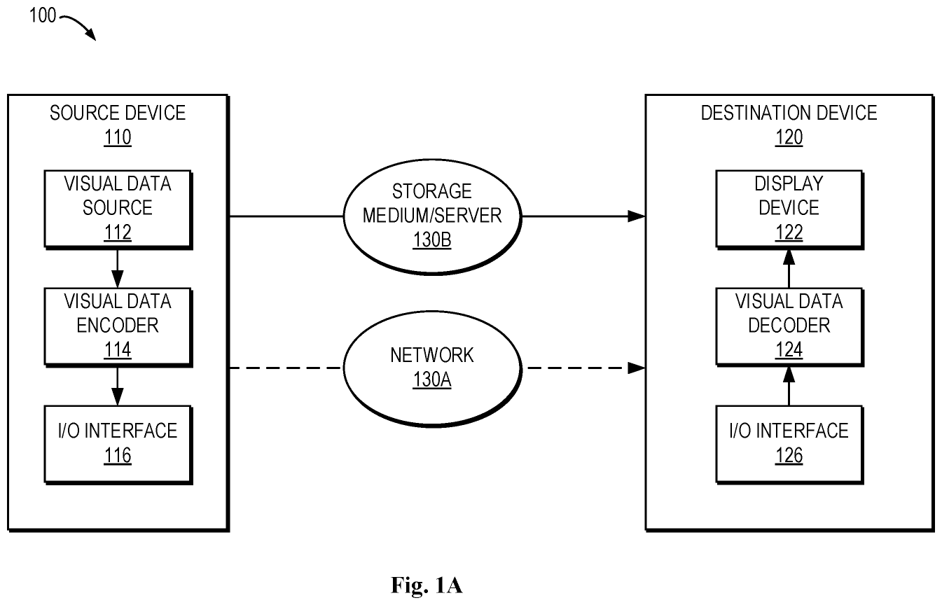

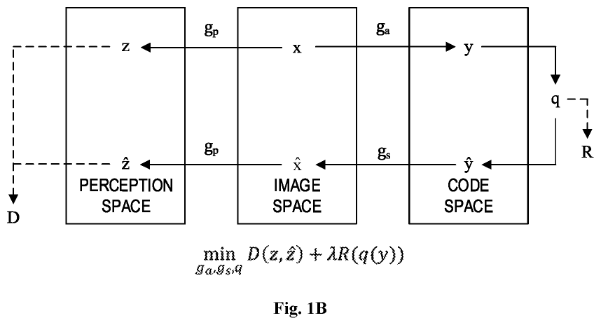

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

This disclosure is on a neural network-based image and video compression method with multiple decoding branches. The same bitstream file can be decoded with one of these branches to obtain the correct reconstructed images/videos.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better. Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1. Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—
log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(x) given its context x₁, x₂, . . . , xᵢ₋₁. The pixel probability is proposed for binary images, i.e., xᵢϵ{−1, +1}. The neural autoregressive distribution estimator (NADE) is designed for pixel probability modeling, where is a feed-forward network with a single hidden layer. A similar work is presented in [8], where the feed-forward network also has connections skipping the hidden layer, and the parameters are also shared. Experiments have been performed on the binarized MNIST dataset. NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. NADE and RNADE are improved by using reorganizing the order of the pixels and with deeper neural networks. Designing advanced neural networks plays an important role in improving pixel probability modeling. Multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. Gated PixelCNN is proposed to improve the PixelCNN and achieves comparable performance with PixelRNN but with much less complexity. PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. PixelSNAIL is proposed, in which casual convolutions are combined with self-attention. Most of the above methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2. Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

FIG. 1 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. It is only needed to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., L=D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, a general framework was proposed for variable rate image compression using RNN. They use binary quantization to generate codes and do not consider rate during training. The framework indeed provides a scalable coding functionality, where RNN with convolutional and deconvolution layers is reported to perform decently. Then an improved version was proposed by upgrading the encoder with a neural network similar to PixelRNN to compress the binary codes. The performance is reportedly better than JPEG on Kodak image dataset using MS-SSIM evaluation metric. The RNN-based solution was further improved by introducing hidden-state priming. In addition, an SSIM-weighted loss function is also designed, and spatially adaptive bitrates mechanism is enabled. They achieve better results than BPG on Kodak image dataset using MS-SSIM as evaluation metric.

A general framework was designed for rate-distortion optimized image compression. They use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified. An improved version was proposed, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, it was further improved by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. The structures were further explored in the residue space by introducing an autoregressive model to estimate both the standard deviation and the mean. In the latest work Gaussian mixture model was used to further remove redundancy in the residue. The reported performance is on par with VVC on the Kodak image set using PSNR as evaluation metric.

### 2.3.3. Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

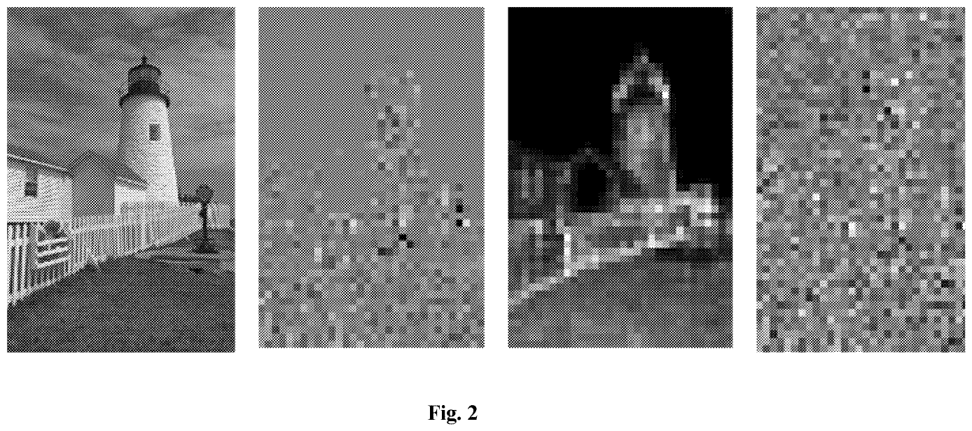

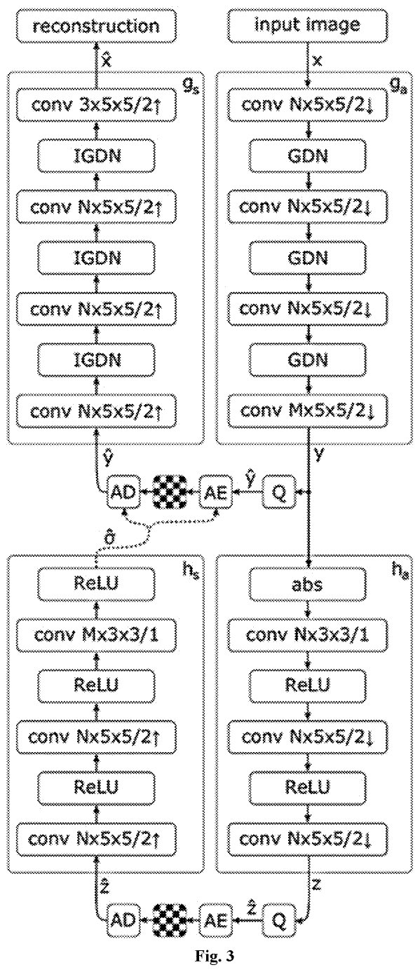

As evident from the middle left and middle right image of FIG. 2, there are significant spatial dependencies among the elements of ŷ. Notably, their scales (middle right image) appear to be coupled spatially. An additional set of random variables \hat{z} are introduced to capture the spatial dependencies and to further reduce the redundancies. In this case the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain 2. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

FIG. 2 illustrates an image from the Kodak dataset (left), a visualization of the latent representation y of that image (middle left), standard deviations σ of the latent (middle right), and latents y after the hyper prior (hyper encoder and decoder) network is introduced (right).

FIG. 3 illustrates a network architecture of an autoencoder implementing the hyperprior model. The left side shows an image autoencoder network, the right side corresponds to the hyperprior subnetwork. The analysis and synthesis transforms are denoted as gₐ and gₛ, respectively. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitstream and transmitted to the receiver (decoder) along with ŷ.

### 2.3.4. Context Model

Although the hyperprior model improves the modelling of the probability distribution of the quantized latent y, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

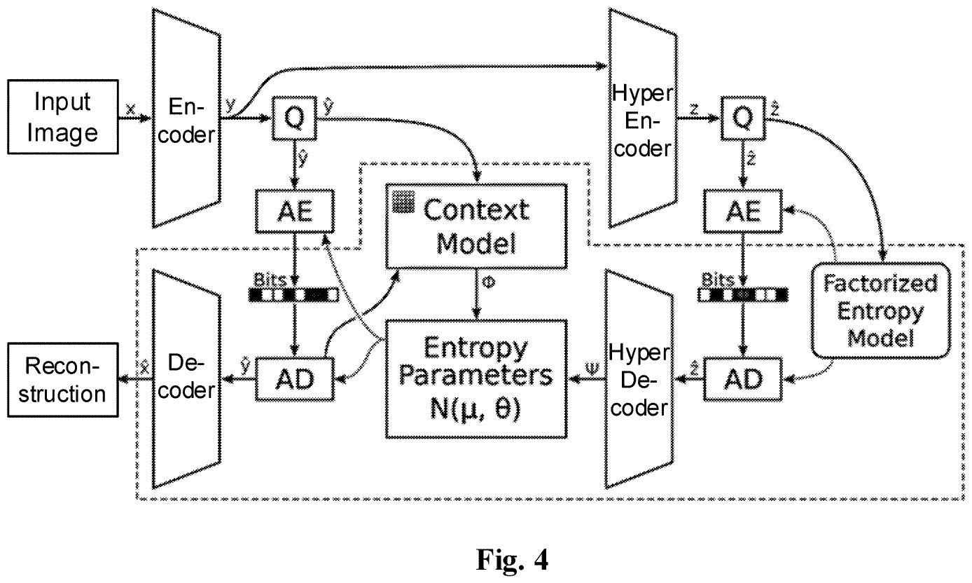

FIG. 4 is a schematic diagram illustrating an example combined model configured to jointly optimize a context model along with a hyperprior and the autoencoder. The following table illustrates meaning of different symbols.

TABLE
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ (y; θₕₑ) |
| Hyper-Latents | z |
| Hyper-Latents (quantized) | \hat{z} |
| Hyper Decoder | gₕ (\hat{z}; θ_{hd}) |
| Context Model | g_{cm} (y_{<i}; θ_{cm}) |
| Entropy Parameters | gₑₚ (·; θₑₚ) |
| Reconstruction | \hat{x} |

A joint architecture was used where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates that the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). According to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5. The Encoding Process Using Joint Auto-Regressive Hyper Prior Model

FIG. 4 corresponds to the state-of-the-art compression method. In this section and the next, the encoding and decoding processes will be described separately.

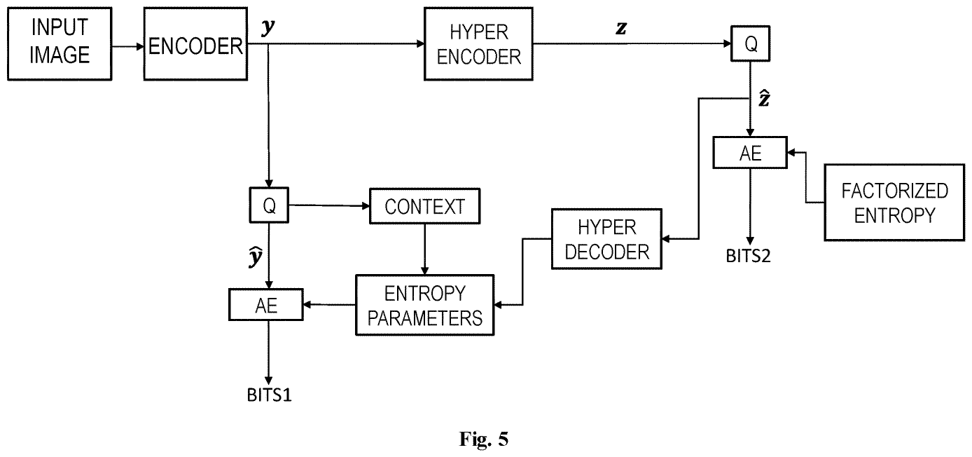

FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module is used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process.

It is noted that the other names can be used for the modules described above.

In the above description, all of the elements in FIG. 5 are collectively called encoder. The analysis transform that converts the input image into latent representation is also called an encoder (or auto-encoder).

### 2.3.6 the Decoding Process Using Joint Auto-Regressive Hyper Prior Model

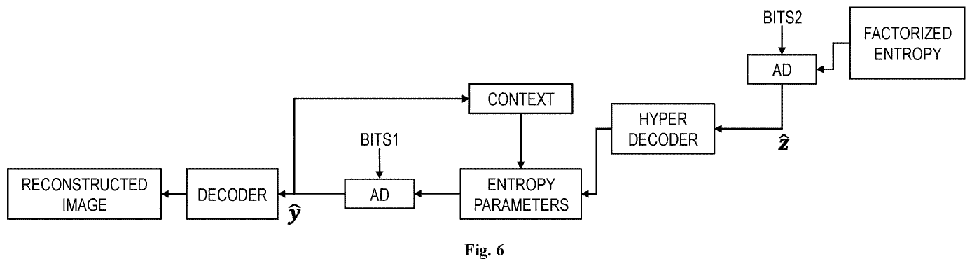

FIG. 6 depicts the state-of-the-art decoding process. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent y that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally, the fully reconstructed quantized latent y is input to the synthesis transform (denoted as decoder in FIG. 6) module to obtain the reconstructed image.

In the above description, all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently. Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1. Low-Latency

The early work first splits the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Another neural network-based video coding scheme with PixelMotionCNN was proposed. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Another end-to-end neural network-based video compression framework is then proposed, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

An advanced neural network-based video compression scheme is proposed. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

An extended end-to-end neural network-based video compression framework is proposed afterwards. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than H.265 by a noticeable margin in terms of both PSNR and MS-SSIM.

The scale-space flow is then proposed to replace commonly used optical flow by adding a scale parameter. It is reportedly achieving better performance than H.264.

A multi-resolution representation for optical flows is proposed. Concretely, the motion estimation network produces multiple optical flows with different resolutions and let the network to learn which one to choose under the loss function. The performance is better than H.265.

### 2.4.2. Random Access

A frame interpolation based method was initially designed. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264. Another interpolation-based video compression is then proposed, wherein the interpolation model combines motion information compression and image synthesis, and the same auto-encoder is used for image and residual.

Afterwards, a neural network-based video compression method based on variational auto-encoders with a deterministic encoder is proposed. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5 Preliminaries

### 2.5.1. The JPEG AI Image Coding Standard

At the time of writing, the JPEG AI image coding standard is an image coding standard that is being standardized by the JPEG Working Group (WG), which is WG 1 of ISO/IEC JTC 1 SC 29. The ISO/IEC number for the JPEG AI standard is ISO/IEC 6048. The latest JPEG AI draft specification is included in JPEG output document WG1N100602.

The design in the latest JPEG AI draft specification utilizes some NN-based image coding methods described mentioned above. Some of the features in the latest JPEG AI specification are described or summarized below.

### 2.5.1.1. Functional Overview of the JPEG AI Decoding Process.

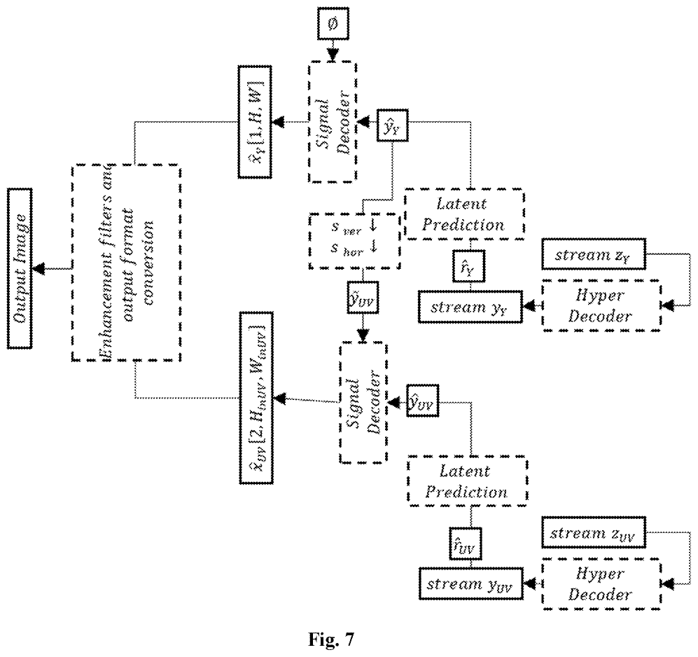

The overall decoder architecture in shown in FIG. 7. Data (tensors and streams) are shown inside the “white” boxes, neural network modules necessary for decoding are shown in grey shadowed boxes, switchable tools are shown in purple shadowed boxes.

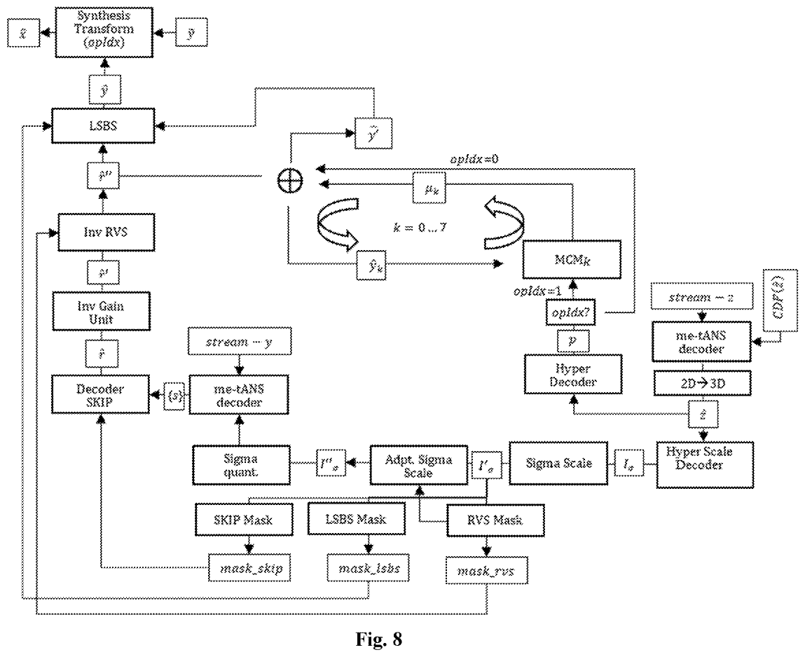

For primary and secondary colour components code streams can be parsed independently and reconstructed using modules consisting of same sequence of same neural-network layers, with the only difference in sizes on input tensors and number of tensor channels. Single component decoder is shown in FIG. 8.

First stream z shall be parsed by loss-less entropy decoder (me—tANS decoder). The probability distribution for loss-less coding of \hat{z} is assumed to be Gaussian with pre-trained parameters (part of the trained model), Commulative Distribution Function (denoted on FIG. 8 as CDF(\hat{z})) computed based on those pre-trained parameters is used in loss-less entropy decoder. Decoded hyper-prior tensors \hat{z} is used as an input for two different processes: Hyper Decoder and Hyper Scale Decoder.

Then stream y shall be parsed by loss-less decoder (me—tANS decoder). The probability distribution for parsing \hat{r} is assumed to be Gaussian with zero mean value and standard deviation given as an output if following steps: Hyper Scale Decoder (section 10.3) outputs tensors of standard deviation in log-domain I_{σ}[C, h₄, w₄], then it is scalled according to the rate control parameter (inside Sigma Scale to produce as I′_{σ}, and then masked and scalled according to RVS parameters section inside Adaptive Sigma Scale producing I″_{σ}. Finally, tensor I″_{σ} values are quantized (converted to the index of probability distribution table). According to the rules, specified by SKIP Mode some elements of residual tensor are skipped (not encoded/decoded) and replaced by zeros in Decoder SKIP module, which receives parsed set of syntax elements {s} from tANS Decoder, mask_sigma from SKIP Mask generation module and outputs re-shaped to 3D shape reconstructed residual tensor \hat{r}[C, h₄, w₄].

At decoder side the residual \hat{r} is scaled by Inverse Gain Unit according to the parameter β, producing \hat{r}′. Then residual tensor is scaled in invRVS (Inverse Residual and Variance Scale) module forming residual tensor \hat{r}″. This is used for reconstructed latent tensor ŷ.

Hyper decoder generates explicit_prediction input to Multi-stage Context Model—MCM, which is eight stages neural network process, which also takes reconstructed residual \hat{r}″ as an input and outputs latent space tensors ŷ′.

After Latent Scaling Before Synthesis-LSBS reconstructed latent space tensor ŷ is ready for signal reconstruction. Latent tensors reconstructions for primary and secondary components are independent from each other.

Reconstructed latent space tensors ŷ[C, h₄, w₄] is an input of Synthesis Transform. Another input of Synthesis transform is auxiliary tensor \tilde{y}[C_{d}, h₄, w₄]. For secondary component Synthesis the auxiliary tensor is generated from primary component reconstructed latent tensor. For primary component no auxiliary tensor is used. Depending on input picture height H and width W and scaling factors for primary (s_{Y}) and secondary (s_{UV}) components sizes of tensors are shown in Table. For primary component the parameter C_{d}=0. This means that primary component's Synthesis transform receives no auxiliary information (reconstructed independently). For secondary component C_{d}=160, the auxiliary for secondary transform synthesis is \tilde{y}_{Y}, which is re-sampled by integer factor s_{UV}/s_{Y} (using nearest neighbour down-sampling or nearest neighbour up-sampling) reconstructed latent space tensor of primary component ŷ_{Y}.

TABLE 1
Tensor size parameters for primary
and secondary components decoding.

| | Primary “Y” | Secondary “UV” |
|---|---|---|
| | component | component |
| Hᵢₙ | H | ceil(H/sᵥₑᵣ) |
| Wᵢₙ | W | ceil(W/sₕₒᵣ) |
| Cᵢₙ | 1 | 2 |
| h_{d}, d = 0, . . . , 6 | ceil(Hᵢₙ/2^{d}) | ceil(Hᵢₙ/2^{(d<4)?d:d-1}) |
| w_{d}, d = 0, . . . , 6 | ceil(Wᵢₙ/2^{d}) | ceil(Wᵢₙ /2^{(d<4)?d:d-1}) |
| C | 160 | 32 |
| C₃ | 96 + 32 * opIdx | 64 |
| C₂ = C₁ | 64 + 64 * opIdx | 64 |
| C_{d} | 0 | 160 |

Synthesis transform for primary and secondary component consists of same neural network layers, the only difference is the size of input tensor and number of tensor channels. Synthesis transform outputs tensor \hat{x}[Cᵢₙ, Hᵢₙ, Wᵢₙ] (tensor sizes are listed in Table 1).

FIG. 7 illustrates a general JPEG AI decoder structure. As shown on FIG. 7 after synthesis transform, the primary and secondary components go to the Enhancement filters and output format conversion processing module, which includes re-sampling, inverse color conversion and set of filters.

FIG. 8 illustrates a JPEG AI decoder for one component.

### 2.5.2. Base OP and High OP

By the time of this draft, there are two operating points in JPEG AI verification model (VM), the base operating point (base OP) and the high operating point (high OP). The base OP is designed in lower complexity, i.e., kMac/pxl. The high OP is designed for better compression efficiency with higher complexity.

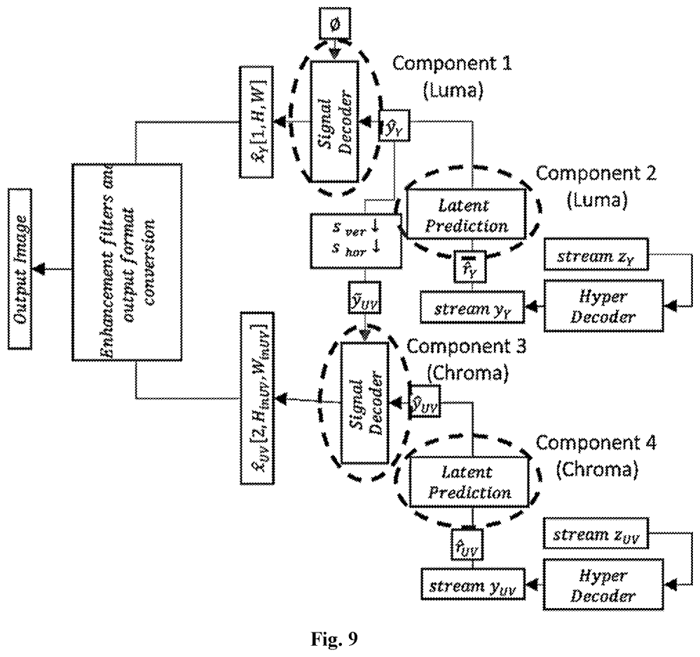

FIG. 9 illustrates a primary difference between base OP and high OP of JPEG AI decoder. In the decoding process, the main differences between the base OP and high OP include the signal decoder and the latent prediction processes, as shown in FIG. 9. In the high OP, the latent prediction is achieved with a multi-stage context model (MCM) and the signal decoder is more complex. In contrast, the base OP does not include the MCM in the latent prediction process and the signal decoder is simpler than the signal decoder in high OP.

The base OP and high OP encoders generate different bitstream files, meaning the decoders of base OP and high OP can only decode the bitstream files generated by corresponding encoders. The high OP decoder will fail if it attempts to decode the bitstream file generated by the base OP encoder, vice versa.

### 3. Problems

### 3.1 The Core Problem

As described in Section 2.5, the JPEG AI VM currently includes two operating points. The base OP and high OP require different bitstreams to reconstruct the picture. There are a few drawbacks in this design. First, the framework is equivalent to having two completely different decoders since they require different bitstreams, making the codec redundant and difficult to maintain. Second, the pretrained models are different, meaning two sets of pretrained models. More pretrained models means more storage is required. Simply limiting the number of decoding branches to 1 will not solve the issue, since in real applications, different coding efficiency and complexities may be required, depending on the application environments.

### 4. Detailed Solutions

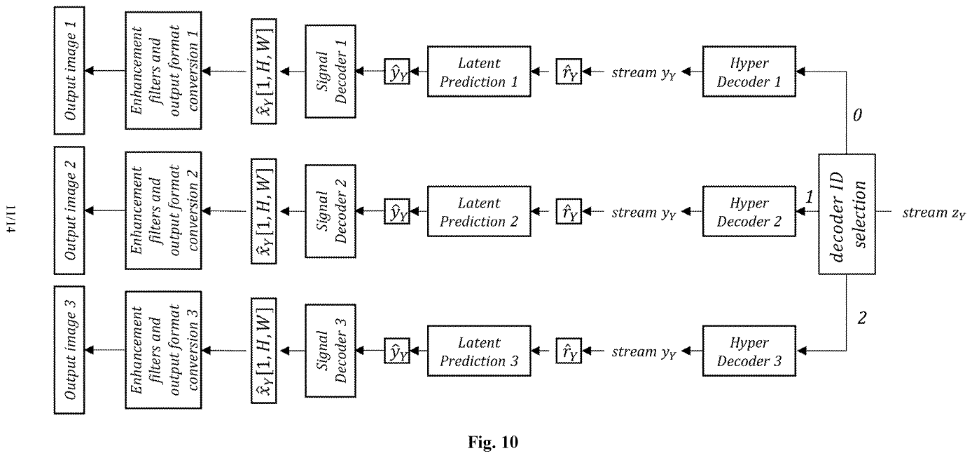

The detailed embodiments below should be considered as examples to explain general concepts. These embodiments should not be interpreted in a narrow way. Furthermore, these embodiments can be combined in any manner. The following examples are illustrated on the luma component (Y) only, and the codec may process luma and chroma components using two sets of convolution models (like shown in FIG. 9). When luma and chroma are processed using two pipelines, the disclosure includes separate multiple branch decoding branches for each of the components. FIG. 10 illustrates an example of decoding the same bitstream of luma component with three branches. FIG. 10 shows an example wherein the luma bitstream z_{Y} can be decoded with three branches to obtain the correct reconstructed images, i.e., output image 1, output image 2 and output image 3. A signal is encoded in the bitstream and in the decoding process it is decoded to indicate which decoding branch to be used to obtain the output image. Among these three branches, they share the same bitstream, stream z_{Y}, but other than that, any component or module could be different, for example, the latent prediction, the signal decoder, etc.

### 4.1. Core of the Solutions

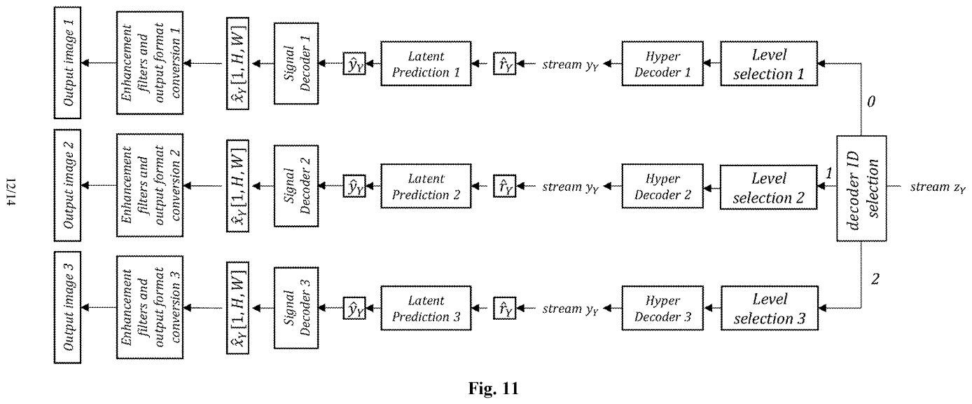

The core of the solutions is a neural network-based image and video codec with multiple decoding branches that the same bitstream can be decoded to obtain the correct reconstructed image. A signal may be encoded in the bitstream to indicate which decoding branch to be used. In each decoding branch, there may be multiple coding levels. FIG. 11 illustrates an example of decoding the same bitstream of luma component with three branches, in each branch multiple levels are supported.

### 5. Embodiments

1. It is proposed that a single bitstream may be decoded with different configurations, resulting in different reconstruction images.
   a. In one example, the number of branches could be any number that is greater than 1, for example, 2, 3, 4, 5, etc.
   b. In one example, as shown in FIG. 11, the multiple decoding branches are implemented with different modules, including the hyper decoder, latent prediction, signal decoder, and enhancement filters and output format conversion. The same bitstream can be decoded with different configurations.
   c. In one example, one or more modules can be shared by all these branches.
      i. For example, in FIG. 11, the enhancement filters and output format conversion module may be shared by all the branches.
      ii. Alternatively, in FIG. 11, the enhancement filters and output format conversion module and the Hyper Decoder module may be shared by all the branches, while the Signal Decoder and Latent prediction modules are different.
      iii. Alternatively, in FIG. 11, the Signal Decoder module is different for different branches while the other modules are shared by all the branches.
   d. In one example, one or more modules may be shared by part of the branches.
      i. For example, in FIG. 11, Hyper Decoder may be shared by the first branch and the second branch, while the third branch has its separate Hyper Decoder.
   e. In one example, at least one syntax element may be signaled in the bitstream to indicate whether the bitstream is able to be decoded with different configurations.
   f. In one example, at least one syntax element may be signaled in the bitstream to indicate which configuration(s) is/are supported to decode the bitstream.
   g. In one example, the syntax element(s) above may be signaled in a conditional way.
   h. The syntax element might be a flag, a syntax element, or a profile indicator.
2. In one example, as shown in FIG. 11, each of the decoding branch may include multiple levels of coding configurations.
   a. In one example, at least one syntax is signaled in the bitstream to indicate which level of decoding is used.
   b. In one example, the syntax element used to select the level may be signaled in a conditional way.
   c. In one example, the syntax element used to select the level may be a flag, a syntax element or a level indicator.
   d. In one example, at least one syntax elements may be signaled in the bitstream to indicate one or more modules are turned on or off.
      i. The module could be convolution layers.
      ii. The module might include neural network-based processing layers such as convolution, or transformer, or activation layers.
      iii. The module could be part of the Signal Decoder in FIG. 11, also known as the synthesis transform.
3. The indication (e.g. syntax element that is included in the bitstream) might indicate any of the following:
   a. A processing module (e.g. an attention block) is included in the processing with the decoder.
   b. A processing module is not included in the processing with the decoder.
   c. Both options are possible. The indication might indicate both outputs (first one obtained using the processing module, the second output obtained without using the processing module) are acceptable.

### General Aspects

4. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
5. Whether to and/or how to apply the disclosed methods above may be dependent on coded information, such as block size, colour format, single/dual tree partitioning, colour component, slice/picture type.
6. The proposed methods disclosed in this document may be used in other coding tools which require chroma fusion.
7. A syntax element disclosed above may be binarized as a flag, a fixed length code, an EG(x) code, a unary code, a truncated unary code, a truncated binary code, etc. It can be signed or unsigned.
8. A syntax element disclosed above may be coded with at least one context model. Or it may be bypass coded.
9. A syntax element disclosed above may be signaled in a conditional way.
   a. The SE is signaled only if the corresponding function is applicable.
   b. The SE is signaled only if the dimensions (width and/or height) of the block satisfy a condition.
10. A syntax element disclosed above may be signaled at block level/sequence level/group of pictures level/picture level/slice level/tile group such level, as in coding structures of CTU/CU/TU/PU/CTB/CB/TB/PB, or sequence header/picture header/SPS/VPS/DPS/DCI/PPS/APS/slice header/tile group header.

More details of the embodiments of the present disclosure will be described below which are related to neural network-based visual data coding. As used herein, the term “visual data” may refer to an image, a picture in a video, or any other visual data suitable to be coded.

As discussed above, in the existing design for neural network (NN)-based visual data coding, there are two different operating points (OPs), i.e., a base OP and a high OP, which generate different bitstreams for a same picture at the encoder side and correspondingly require different bitstreams to reconstruct the picture at the decoder side. Such a design is equivalent to is having two completely different codecs. This severely restricts the coding flexibility and thus the coding efficiency decreases.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

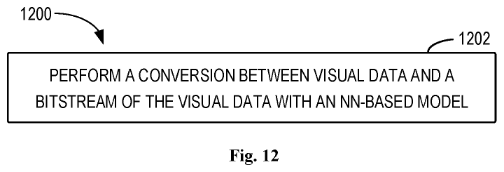

FIG. 12 illustrates a flowchart of a method 1200 for visual data processing in accordance with some embodiments of the present disclosure. At 1202, a conversion between the visual data and a bitstream of the visual data is performed with a neural network (NN)-based model. In some embodiments, the conversion may include encoding the visual data into the bitstream. Additionally or alternatively, the conversion may include decoding the visual data from the bitstream. By way of example rather than limitation, the decoding model shown in FIG. 6 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, the bitstream comprises a first indication indicating a level to which the bitstream conforms. For example, the bitstream may be decoded by using the level indicated by the first indication. In addition, the level indicated by the first indication may be one of a plurality of predetermined levels for coding the bitstream. By way of example rather than limitation, the first indication may be implemented with a syntax element, a flag, or a profile indicator.

In some embodiments, levels may specify restrictions on bitstreams and hence limits on the capabilities needed to decode the bitstreams. By way of example, each level may specify a set of limits on the values that may be taken by the syntax elements. It should be understood that the possible implementations of the levels described here are merely illustrative and therefore should not be construed as limiting the present disclosure in any way.

In view of the above, the bitstream comprises an indication indicating a level to which the bitstream conforms. Compared with the conventional solution lacking such an indication, the proposed method can advantageously support different levels of coding configurations. Thereby, the coding flexibility and coding efficiency can be improved.

In some embodiments, the conversion may be performed based on a plurality of decoding profiles for decoding the bitstream. The plurality of decoding profiles may be different from each other. For example, a decoding profile may be a specific decoding configuration, e.g., a specific structure of the NN-based model, a specific decoding scheme, a branch of decoding modules in the NN-based model or the like. In addition, a decoding profile may correspond to a specific reconstruction of the visual data. By way of example, different reconstructions of the visual data corresponding to the plurality of decoding profiles may have different qualities. If a bitstream is allowed to be decoded based on a specific decoding profile, this decoding profile may be descried as being supported by the bitstream. In some embodiments, each of the plurality of decoding profiles may be supported by the bitstream. Alternatively, one or more decoding profiles in the plurality of decoding profiles may be supported by the bitstream.

By way of example, a same encoding profile may be used to encoding the visual data into a bitstream, and this bitstream may be allowed to be decoded based on the plurality of decoding profiles. In practice, one or more decoding profiles may be selected from the plurality of decoding profiles and used to decode the profile. This will be descried in detail below.

In some embodiments, the number of the plurality of decoding profiles may be 2, 3, 4, or the like. It should be understood that the specific values recited herein are intended to be exemplary rather than limiting the scope of the present disclosure.

In some embodiments, the plurality of decoding profiles may be different in terms of a synthesis transform. For example, a synthesis transform used in one of the plurality of decoding profiles may be different from a synthesis transform used in another one of the plurality of decoding profiles. In addition or alternatively, at least one of the following may be different for the plurality of decoding profiles: a hyper decoder, a module for predicting a latent representation of the visual data, a synthesis transform, an enhancement filter, or a module for output format conversion.

In some embodiments, one or more modules in the NN-based model may be identical for the plurality of decoding profiles. In other words, these one or more modules are shared by the different decoding profiles. By way of example, the one or more modules may comprise a module for predicting a latent representation of the visual data, an entropy decoder, a hyper decoder, an enhancement filter, a module for output format conversion, or any suitable combination thereof.

In some additional or alternative embodiments, at least one module in the NN-based model may be identical for a part of the plurality of decoding profiles. For example, the at least one module may be shared by two decoding profiles and differ from corresponding module(s) used in a third decoding profile. By way of example rather than limitation, at least one module may comprise a hyper decoder, and/or the like.

In some embodiments, the bitstream may further comprise a second indication indicating one or more supported decoding profiles provided by the bitstream. For example, one or more decoding profiles supported by the bitstream may be indicated by the second indication. Moreover, at the decoder side, the bitstream may be decoded by using the one or more supported decoding profiles. By way of example, the second indication may be implemented with at least one syntax element.

In some embodiments, the bitstream may further comprise an indication indicating whether the bitstream is able to be decoded with different decoding profiles. Additionally or alternatively, the bitstream may further comprise an indication indicating whether one or more modules in the NN-based model are enabled or disabled. By way of example, the one or more modules comprise a convolution layer, an NN-based processing layer (such as a transform layer, an activation layer, or the like), a part of a synthesis transform, and/or the like.

In some embodiments, the bitstream further comprises an indication indicating one of the following: a first option where a processing module may be used for decoding the bitstream, a second option where the processing module may be not used for decoding the bitstream, or both the first option and the second option may be acceptable.

In some embodiments, first information regarding at least one of the following may be indicated in the bitstream: whether to apply the method, or how to apply the method. For example, the first information may be indicated at one of the following: a block level, a sequence level, a group of pictures level, a picture level, a slice level, or a tile group level. Additionally or alternatively, the first information may be indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the first information may be dependent on coded information of the visual data. By way of example, the coded information may comprise a block size, a color format, a single tree partitioning, a dual tree partitioning, a color component, a slice type, and/or a picture type.

In some embodiments, any of the above-mentioned indication may be a syntax element. For example, the syntax element may be binarized as one of the following: a flag, a fixed length code, an exponential Golomb (EG) code, a unary code, a truncated unary code, or a truncated binary code. Additionally, the syntax element may be coded with at least one context model. Alternatively, the syntax element may be bypass coded.

In some embodiments, the syntax element may be signaled based on a condition. For example, the syntax element is signaled only if the corresponding function is applicable. Alternatively, the syntax element is signaled only if a dimension (width and/or height) of a block of the visual data satisfies a condition.

In some embodiments, the syntax element may be indicated at a block level, a sequence level, a group of pictures level, a picture level, a slice level, or a tile group level. Additionally or alternatively, the syntax element may be indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: performing a conversion between the visual data and the bitstream with a neural network (NN)-based model, the bitstream comprising a first indication indicating a level to which the bitstream conforms.

According to still further embodiments of the present disclosure, a method for storing bitstream of visual data is provided. The method comprises: performing a conversion between the visual data and the bitstream with a neural network (NN)-based model, the bitstream comprising a first indication indicating a level to which the bitstream conforms; and storing the bitstream in a non-transitory computer-readable recording medium.

Implementations of the present disclosure can be described in view of the following clauses, the features of which can be combined in any reasonable manner.

Clause 1. A method for visual data processing, comprising: performing a conversion between visual data and a bitstream of the visual data with a neural network (NN)-based model, the bitstream comprising a first indication indicating a level to which the bitstream conforms.

Clause 2. The method of clause 1, wherein the first indication comprises a syntax element.

Clause 3. The method of any of clauses 1-2, wherein the level indicated by the first indication is one of a plurality of predetermined levels for coding the bitstream.

Clause 4. The method of any of clauses 1-3, wherein the conversion is performed based on a plurality of decoding profiles for decoding the bitstream, and the plurality of decoding profiles are different from each other.

Clause 5. The method of clause 4, wherein the number of the plurality of decoding profiles is 3.

Clause 6. The method of any of clauses 4-5, wherein a synthesis transform used in one of the plurality of decoding profiles is different from a synthesis transform used in another one of the plurality of decoding profiles.

Clause 7. The method of any of clauses 4-6, wherein one or more modules in the NN-based model are identical for the plurality of decoding profiles.

Clause 8. The method of clause 7, wherein the one or more modules comprise at least one of the following: a module for predicting a latent representation of the visual data, or an entropy decoder.

Clause 9. The method of any of clauses 4-8, wherein the bitstream further comprises a second indication indicating one or more supported decoding profiles provided by the bitstream.

Clause 10. The method of clause 9, wherein the second indication comprises at least one syntax element.

Clause 11. The method of any of clauses 9-10, wherein the bitstream is decoded by using the one or more supported decoding profiles.

Clause 12. The method of any of clauses 4-6, wherein at least one of the following is different for the plurality of decoding profiles: a hyper decoder, a module for predicting a latent representation of the visual data, a synthesis transform, an enhancement filter, or a module for output format conversion.

Clause 13. The method of any of clauses 7-8, wherein the one or more modules comprise at least one of the following: a hyper decoder, an enhancement filter, or a module for output format conversion.

Clause 14. The method of any of clauses 4-6, wherein at least one module in the NN-based model is identical for a part of the plurality of decoding profiles.

Clause 15. The method of clause 14, wherein the at least one module comprises a hyper decoder.

Clause 16. The method of any of clauses 1-15, wherein the bitstream further comprises an indication indicating whether the bitstream is able to be decoded with different decoding profiles.

Clause 17. The method of any of clauses 1-16, wherein the bitstream further comprises an indication indicating whether one or more modules in the NN-based model are enabled or disabled.

Clause 18. The method of clause 17, wherein the one or more modules comprise at least one of the following: a convolution layer, an NN-based processing layer, or a part of a synthesis transform.

Clause 19. The method of any of clauses 1-18, wherein the bitstream further comprises an indication indicating one of the following: a first option where a processing module is used for decoding the bitstream, a second option where the processing module is not used for decoding the bitstream, or both the first option and the second option are acceptable.

Clause 20. The method of any of clauses 1-19, wherein first information regarding at least one of the following is indicated in the bitstream: whether to apply the method, or how to apply the method.

Clause 21. The method of clause 20, wherein the first information is indicated at one of the following: a block level, a sequence level, a group of pictures level, a picture level, a slice level, or a tile group level.

Clause 22. The method of clause 20, wherein the first information is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 23. The method of any of clauses 20-22, wherein the first information is dependent on coded information of the visual data.

Clause 24. The method of clause 23, wherein the coded information comprises at least one of the following: a block size, a color format, a single tree partitioning, a dual tree partitioning, a color component, a slice type, or a picture type.

Clause 25. The method of any of clauses 1-24, wherein an indication comprises a syntax element.

Clause 26. The method of clause 25, wherein the syntax element is binarized as one of the following:

a flag, a fixed length code, an exponential Golomb (EG) code, a unary code, a truncated unary code, or a truncated binary code.

Clause 27. The method of any of clauses 25-26, wherein the syntax element is coded with at least one context model, or wherein the syntax element is bypass coded.

Clause 28. The method of any of clauses 25-27, wherein the syntax element is signaled based on a condition.

Clause 29. The method of any of clauses 25-28, wherein the syntax element is indicated at one of the following: a block level, a sequence level, a group of pictures level, a picture level, a slice level, or a tile group level.

Clause 30. The method of any of clauses 25-29, wherein the syntax element is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information

(DCI), a picture parameter set (PPS), an adaptation parameter sets (APS), a slice header, or a tile group header.

Clause 31. The method of any of clauses 1-30, wherein the visual data comprise a video, a picture of the video, or an image.

Clause 32. The method of any of clauses 1-31, wherein the conversion includes encoding the visual data into the bitstream.

Clause 33. The method of any of clauses 1-31, wherein the conversion includes decoding the visual data from the bitstream.

Clause 34. An apparatus for visual data processing comprising a processor and a non-transitory memory with instructions thereon, wherein the instructions upon execution by the processor, cause the processor to perform a method in accordance with any of clauses 1-33.

Clause 35. A non-transitory computer-readable storage medium storing instructions that cause a processor to perform a method in accordance with any of clauses 1-33.

Clause 36. A non-transitory computer-readable recording medium storing a bitstream of visual data which is generated by a method performed by an apparatus for visual data processing, wherein the method comprises: performing a conversion between the visual data and the bitstream with a neural network (NN)-based model, the bitstream comprising a first indication indicating a level to which the bitstream conforms.

Clause 37. A method for storing a bitstream of visual data, comprising: performing a conversion between the visual data and the bitstream with a neural network (NN)-based model, the bitstream comprising a first indication indicating a level to which the bitstream conforms; and storing the bitstream in a non-transitory computer-readable recording medium.

### Example Device

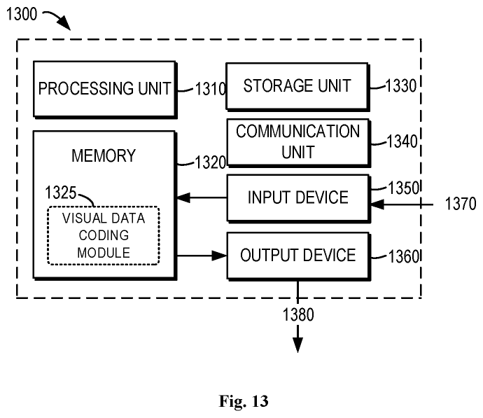

FIG. 13 illustrates a block diagram of a computing device 1300 in which various embodiments of the present disclosure can be implemented. The computing device 1300 may be implemented as or included in the source device 110 (or the visual data encoder 114) or the destination device 120 (or the visual data decoder 124).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or visual data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement visual data encoding/decoding in embodiments of the present disclosure. The memory 1320 may include one or more visual data coding modules 1325 having one or more program instructions. These modules are accessible and executable by the processing unit 1310 to perform the functionalities of the various embodiments described herein.

In the example embodiments of performing visual data encoding, the input device 1350 may receive visual data as an input 1370 to be encoded. The visual data may be processed, for example, by the visual data coding module 1325, to generate an encoded bitstream. The encoded bitstream may be provided via the output device 1360 as an output 1380.

In the example embodiments of performing visual data decoding, the input device 1350 may receive an encoded bitstream as the input 1370. The encoded bitstream may be processed, for example, by the visual data coding module 1325, to generate decoded visual data. The decoded visual data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between visual data and a bitstream of the visual data with a neural network (NN)-based model, the bitstream comprising a first indication indicating a level to which the bitstream conforms.

2. The method of claim 1, wherein the first indication comprises a syntax element.

3. The method of claim 1, wherein the level indicated by the first indication is one of a plurality of predetermined levels for coding the bitstream.

4. The method of claim 1, wherein the conversion is performed based on a plurality of decoding profiles for decoding the bitstream, and the plurality of decoding profiles are different from each other.

5. The method of claim 4, wherein the number of the plurality of decoding profiles is 3.

6. The method of claim 4, wherein a synthesis transform used in one of the plurality of decoding profiles is different from a synthesis transform used in another one of the plurality of decoding profiles.

7. The method of claim 4, wherein one or more modules in the NN-based model are identical for the plurality of decoding profiles.

8. The method of claim 7, wherein the one or more modules comprise at least one of the following:
a module for predicting a latent representation of the visual data, or
an entropy decoder.

9. The method of claim 4, wherein the bitstream further comprises a second indication indicating one or more supported decoding profiles provided by the bitstream.

10. The method of claim 9, wherein the second indication comprises at least one syntax element.

11. The method of claim 4, wherein the bitstream is decoded by using the one or more supported decoding profiles.

12. The method of claim 1, wherein the bitstream further comprises an indication indicating one of the following:
a first option where a processing module is used for decoding the bitstream,
a second option where the processing module is not used for decoding the bitstream, or
both the first option and the second option are acceptable.

13. The method of claim 1, wherein the visual data comprise a video, a picture of the video, or an image.

14. The method of claim 1, wherein the conversion includes encoding the visual data into the bitstream.

15. The method of claim 1, wherein the conversion includes decoding the visual data from the bitstream.

16. The method of claim 1, wherein the conversion comprises: generating the bitstream from the visual data, and
the method further comprises: storing the bitstream in a non-transitory computer-readable recording medium.

17. An apparatus for visual data processing comprising a processor and a non-transitory memory with instructions thereon, wherein the instructions upon execution by the processor, cause the processor to perform operations comprising:
performing a conversion between visual data and a bitstream of the visual data with a neural network (NN)-based model, the bitstream comprising a first indication indicating a level to which the bitstream conforms.

18. The apparatus of claim 17, wherein the first indication comprises a syntax element, or
wherein the level indicated by the first indication is one of a plurality of predetermined levels for coding the bitstream, or
wherein the conversion is performed based on a plurality of decoding profiles for decoding the bitstream, and the plurality of decoding profiles are different from each other.

19. A non-transitory computer-readable storage medium storing instructions that cause a processor to perform operations comprising:
performing a conversion between visual data and a bitstream of the visual data with a neural network (NN)-based model, the bitstream comprising a first indication indicating a level to which the bitstream conforms.

20. The non-transitory computer-readable storage medium of claim 19, wherein the first indication comprises a syntax element, or
wherein the level indicated by the first indication is one of a plurality of predetermined levels for coding the bitstream, or
wherein the conversion is performed based on a plurality of decoding profiles for decoding the bitstream, and the plurality of decoding profiles are different from each other.
